(19) United States
(12) Patent Application Publication
(10) Pub. No.: US 2026/0222420 A1
(43) Pub. Date: Jul. 30, 2026

(54) RISK MITIGATION IN NETWORKS

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,003

(22) Filed: Jan. 28, 2025

(51) Int. Cl. H04L 9/40; G06N 3/042; G06N 3/0475

(52) U.S. Cl. CPC H04L 63/1416; G06N 3/042; G06N 3/0475; H04L 63/1441

(57) ABSTRACT

Generalized risk management is disclosed. When an event related to a network is identified, a request is generated and sent to a prompt generator. The prompt generator generates a prompt based on the request, key performance indicators of the network, and a semantic state of the network, which is generated by a first model. The prompt is input to a second model and the second model identifies risks associated with the event and/or generates a recommended potential solution to a potential incident caused by the event should the event occur. An agent may evaluate the risks and/or the recommended potential solution and send a command to the network to mitigate the risks and/or resolve the incident should the incident occur. The prompt generator also generates the prompt using a graph neural network and/or a knowledge base. The network incident management can be automated and/or include a human-in-the-loop.

### TECHNOLOGICAL FIELD OF THE DISCLOSURE

Embodiments disclosed herein generally relate to generative artificial intelligence (GenAI) for networks including telecommunication networks. More particularly, at least some embodiments relate to systems, hardware, software, computer-readable media, and methods for GenAI-based risk management, including risk mitigation, in telecommunication networks.

### BACKGROUND

Telecommunication networks are large, complex, and heterogenous. Keeping a telecommunications up and running is a challenging task that can be impacted by any number of different events. In fact, many events are associated with a risk that the operations and functions of a telecommunication network will be adversely affected.

In telecommunication networks, incidents (e.g., degraded performance, outage) may occur due to network management operations, due to forces outside the control of the network, component failure, or for other reasons. For example, some events, such as network updates and network upgrades, occur in the normal course of operating the telecommunications network. Nonetheless, each update or each upgrade is still associated with the risk of causing an incident. In addition these types of events, other events such as concerts and weather may also cause incidents in the network. The impact and scale of the potential incidents associated with these types of events is typically unknown, due in part to the heterogeneous nature of the telecommunication network and the inter-dependencies that exist therein.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of a framework, architecture, or system for risk management;

FIG. 1B discloses aspects of a heterogenous network;

FIG. 1C discloses aspects of a radio intelligent controller configured to perform risk management using multiple agentic models;

FIG. 1D discloses aspects of a method for performing risk management in a network or in response to an event or an anticipated event;

FIG. 2 discloses aspects of risk management using agentic models and graph neural networks;

FIG. 3 discloses aspects of risk management using agentic models, graph neural networks, and knowledge bases; and

FIG. 4 discloses aspects of a computing device, a computing system, and/or a computing entity.

### DETAILED DESCRIPTION OF SOME EXAMPLE EMBODIMENTS

Embodiments disclosed herein generally relate to risk management in networks including radio access networks such as telecommunications networks. More particularly, at least some embodiments relate to systems, hardware, software, computer-readable media, and methods for risk management in telecommunication networks using models that may include, but are not limited to, agentic foundation models (AFMs) and/or large language models (LLMs).

Artificial intelligence/machine learning (AI/ML) for networks, including telecommunication networks, typically have generalization limitations (e.g., for network topologies and conditions) and have difficulty coordinating multi-vendor and multi-agent solutions. These deficiencies complicate the ability to understand the internal operations and relationships found in networks such as telecommunications networks. This difficulty extends to risk management.

Embodiments of the invention relate to AI/ML deployments, including large scale deployments, in networks that overcome generalization limitations and coordination concerns. More specifically, embodiments of the invention are able to adapt to new network topologies and conditions, coordinate multi-vendor multi-agent applications, generalize to heterogenous networks, account for component/application/network inter-dependencies, and the like.

Embodiments of the invention are configured to provide orchestration and generalization capabilities and enable semantic communications in the context of risk management, which may include risk assessment and/or risk mitigation. Risk mitigation may include recommending a solution in advance of an anticipated incident or otherwise preparing for an incident that may be caused by an event.

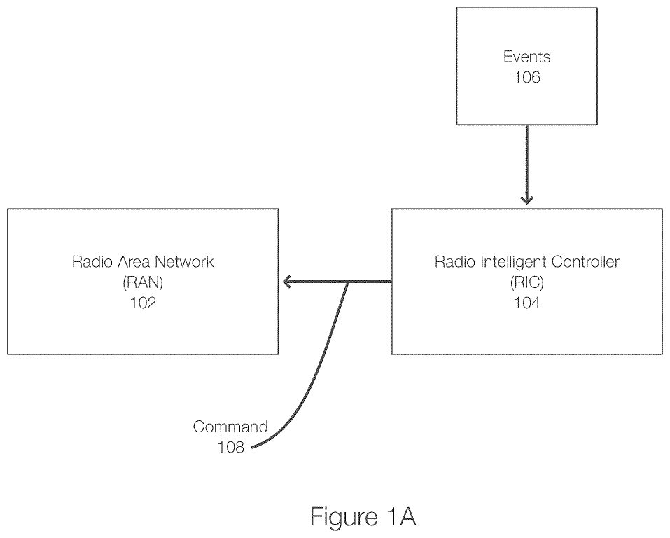

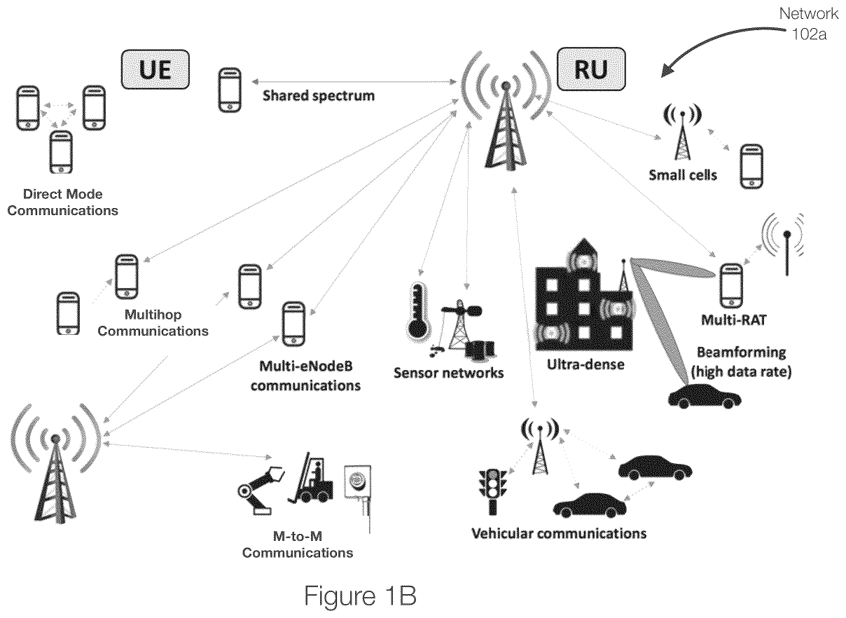

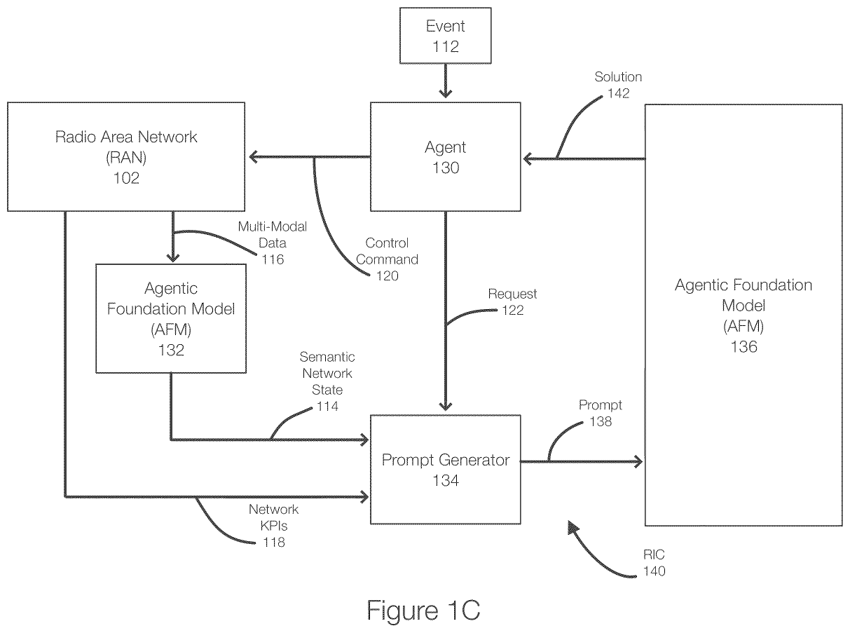

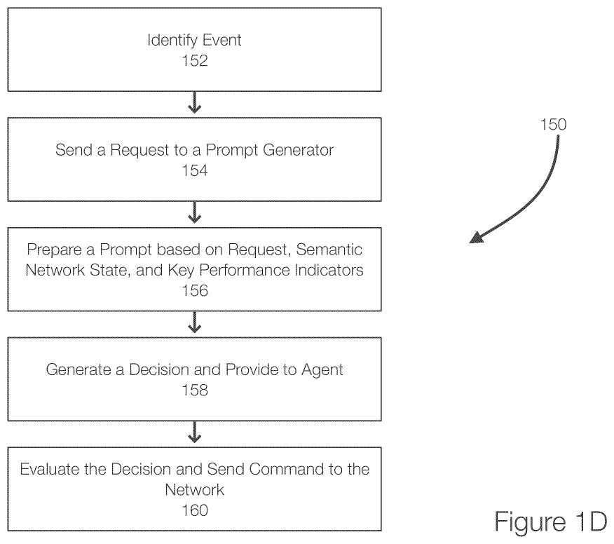

FIG. 1A illustrates an example of a radio intelligent controller associated with a network. FIG. 1A more specifically illustrates a radio access network (RAN) 102 (or open radio access network (O-RAN), and a radio intelligent controller (RIC) 104. The RIC 104 is configured to perform risk management. Risk management is discussed in this disclosure in terms of events 106. In one example, the events 106 refer, by way of example only, to activities, actions, and/or scenarios that may pose a risk to the network 102 or more specifically to the functions and operations of the network 102. For example, events 106 such as network upgrades or updates are typically scheduled in advance and are example of events that are performed in the network 102 and are typically under the control of network administrators. The events 106 may also include external events (e.g., weather conditions) that are not under the control of network administrators, but may still cause an incident in the network 102.

The RIC 104 may detect or identify the events 106 in different manners. For example, a network administrator may advise the RIC 104 of impending or scheduled events (e.g., maintenance, upgrades, updates). Events 106 such as weather conditions may be identified or received using a message queue or the like. For example, severe weather warnings may trigger the delivery of an event to the RIC 104. Calendaring systems may advise the RIC 104 of scheduled events such as concerts.

The events 106 may be accompanied by metadata. An update may include metadata identifying the target of the update (e.g., a server, a radio, an application). This metadata may also include geographical information, timing information (e.g., update start time), version number, or the like. Events such as concerts may include metadata describing the location, anticipated attendance, and the like.

The RIC 104, upon receiving an event, may assess or evaluate a risk associated with the event and/or generate a potential solution to a potential incident. The RIC 104 may perform other actions such as generate alerts related to the event and/or the potential risk, make a recommendation for resolving an incident caused by the event, request human input, or the like or combinations thereof.

In this example, the network 102 is representative of networks in general. The network 102 may include radios (cell towers), communication infrastructure, end user devices (e.g., smart phones, tablets, computers, local networks), or the like. For example, the network 102 may be a wireless network, a telecommunications network, an O-RAN (Open Radio Access Network), or the like or combinations thereof. The network 102 may be a heterogenous network and be associated with multiple applications, hardware components (e.g., radios, towers, sub-networks, servers, end user devices). The nature of the network 102, which may be large, suggests that many of the applications/hardware components that form the network 102 may be provided by multiple vendors, have different versions/operating systems/specifications, and the like. Further, many of these applications/components/hardware may have inter-dependencies that are not necessarily known. More specifically, this heterogeneity may cause various inter-dependencies that may or may not be known.

For a variety of reasons, events occur with respect to the network 102 and the RIC 104 is configured to perform risk management operations. Generally, risk management may include, in response to an event, evaluating and/or identifying risks associated with the event. Risk management may also include risk mitigation operations such as generating a recommended solution or potential solution to incidents that may be caused by the event in the network 102. Embodiments of the invention, more specifically, may generate a recommended or potential solution that is aware of network inter-dependencies. This helps ensure that risk-mitigation actions to not increase the risk or cause an incident. Risk management may also include documenting the risk management operations for various reasons including the ability to audit the manner in which risks were managed or mitigated. For instance, it may be necessary to review actions or operations in an automated manner and/or by humans-in-the-loop.

An incident, by way of example, may include degraded performance, a network outage, unwanted intrusions (physical or network-based), unusual or unauthorized activity, equipment damage (e.g., weather-related), failure to meet or satisfy service level agreements, and the like or combinations thereof. These incidents are examples of what may occur due to an event. As previously stated, the complexity and heterogeneity of the network 102 makes risk management a challenging and difficult task and embodiments of the invention relate to identifying the risks based on the events that are anticipated.

The RIC 104 may include agentic foundation models (AFMs) (or other models such as large models (LMs) or large language models (LLMs)) for performing aspects of risk management. These models are trained on relevant historical data. More specifically, these models may be fine-tuned using data relevant to the network 102. For example, a model may be trained using network logs, network reports, standards data, incidents, or the like or combination thereof. This helps ensure that any solutions recommended by the RIC 104 account for the network, normal network operations, and for relevant standards, incidents, service level agreements, or the like. The network logs, network reports, standards data, incidents, or the like may include data related to previous events, whether incidents were caused by the events, previous solutions to the events, and the like.

Advantageously, training the model on network data allows any recommendations/commands/solutions determined by the RIC 104 to account for inter-dependencies at least because the inter-dependencies are reflected in the network logs and reports and/or in the fine-tuning performed. The RIC 104 can provide or identify the risks associated with an event and/or provide an informed and targeted solution to incidents that may be caused by the event. In one example, solutions to incidents caused by or related to events can be remedied more quickly at least because a solution may be recommended in advance. For example, an incident caused by an event can be resolved in an automated manner (e.g., changing a setting) or may require human intervention (e.g., replacing a bad or defective network component). In some examples, protective actions may be taken in advance of the event. In another example, an event may be cancelled (e.g., a proposed upgrade), thereby avoiding the potential incident.

This is beneficial in part because the RIC 104 may identify an unknown problem with a proposed or scheduled upgrade or update. Identifying the risk may allow the upgrade or update to be revised prior to deployment in order to avoid the risk or mitigate the risk.

FIG. 1B illustrates an example of a network. More specifically, FIG. 1B illustrates a network 102a, which is an example of the network 102. In this example, the network 102a includes towers, small cells, user equipment, multihop communications, multi-enodeB communications, sensor networks, vehicular communications, M-to-M communications, ultra-dense networks multi-RAT, beamforming, and the like. The network 102a illustrates the complexity of resolving incidents due to the heterogeneity of the network 102a. Many of the components generate logs and reports, are associated with multiple standards, and are of different types. Models that are trained with these logs, reports, and standards can account for inter-dependencies. Training a model to learn the risks associated with events allows the risk of an event to be mitigated before the event is performed or occurs. This further illustrates the benefits of risk management that may be able to anticipate events and mitigate potential incidents by providing potential solutions to the potential incidents in advance.

FIG. 1C illustrates an example of a framework, architecture, system, or controller for risk management. FIG. 1C illustrates the network 102 and an RIC 140 (an example of the RIC 104), which may include an agent 130, an AFM 132, a prompt generator 134, and/or an AFM 136.

In this example, the network 102 may detect, receive, or otherwise identify an event 112. As previously stated, the event 112 may be, by way of example only, an update, an upgrade, a request, a weather event, a concert, or the like or combinations thereof. In response to the event 112, the agent 130 generates a request 122 that is provided to the prompt generator 134. The prompt generator 134 may be configured to construct a prompt 138.

At the same time, network key performance indicators (KPIs) 118 are available to the prompt generator 134. In addition, an agentic foundation model (AFM) 132 is configured to receive multi-modal data 116 from the network 102. The AFM 132 is trained on historical multi-modal data and is configured to generate a semantic network state 114, which is input to or available to the prompt generator 134 and which may be embedded.

In one example, the prompt generator 134 builds a prompt 138 based on the network KPIs 118, the embedded semantic network state 114, and/or the request 122, which includes aspects of the event 112. The prompt 138 is input to the AFM 136.

The AFM 136 is configured (trained) to make a decision (generate a recommended solution, identify risks associated with the event) regarding the event 112. The AFM 136 thus makes a decision, which is provided to the agent 130. The agent 130 may evaluate the decision (automatically and/or with a human-in the-loop in one example) and send a control command 120 to the network 102. The command 120 may be generated before the event 112 actually occurs, after an incident caused by the event 112 is detected, or the like.

The AFM 132 and the AFM 136 are trained with historical data that represent inter-dependencies among at least network components and applications in the network 102. Because these types of relationships and inter-dependencies are reflected in the network data (e.g., the KPIs 118, the multi-modal data 116), the decision made by or recommended by the AFM 136 identifies risks associated with the event 112 and/or provides a targeted solution to incidents that may be caused by the event 112.

FIG. 1D discloses aspects of a method for performing risk management. The method 150 includes receiving 152 an event from the network. The event may be, as previously stated, a request (e.g., an update, an upgrade, large activity (e.g., concert), maintenance), or the like. In response to the event, a request is sent 154 to a prompt generator. The request may include aspects (e.g., metadata, documents) of the event. The prompt generator generates or prepares 156 a prompt based on the request, a semantic network state output by an AFM model, and KPIs of the network. The prepared prompt is input into a second AFM, which generates 158 a decision (e.g., a recommended solution to an incident that may be caused or associated with the event) and provides the decision to the agent. The decision is evaluated 160 by the agent and, if approved, sent to or implemented in the network. The decision may be, by way of example only, preemptory in nature and implemented prior to the event or implemented in response to an incident detected in the network. In one example, because the decision may identify risks, the decision may prevent the event from occurring until the risks are addresses or further mitigated.

Returning to FIG. 1C, the AFM 132 is configured to generate a semantic network state 114 that is aware of the inter-relationships or inter-dependencies among network components, applications, and the like. The AFM 136 is configured to generate a decision related to the event 112 that is aware of the inter-dependencies among network components and applications. More specifically, the decision may identify the risks associated with the event.

For example, if the event 112 is an upgrade and documents related to an upgrade are included in the request, the AFM 136 may be able to determine that the upgrade is not compatible with products from certain vendors, may prevent one radio from communicating with another radio, or the like. As such, the risk identified in the decision is that an outage or performance degradation may occur with respect to specific towers. Even if the upgrade is for a specific tower, for instance, the learned inter-dependencies allows potential risks to be identified.

In addition, embodiments of the invention provide a faster mean time to repair (e.g., lower MTTR) in the scenario that the event is permitted and an incident occurs at least because the AFM 136 may identify a potential solution to the incident. FIGS. 1A-1D also facilitate a human in the loop in the context of AFMs 132 and 136.

In one example, the AFM 132 receives multi-modal data 116. By way of example only, the multi-modal data 116 may include two-dimensional images, three dimensional images, LiDAR (Light Detection and Ranging) data, sensor data, Internet of Things (IoT) data, and/or the like, which may be generated in the network 102. The multi-modal data may also include sensor data such as wind speed/direction, pressure, precipitation, temperature, and the like. The AFM 132 is trained on multi-modal data and is configured to generate a semantic network state 114 (e.g., embeddings or vectors representing the semantic network state). For example, image data from sensors (e.g., cameras, surveillance cameras, drones, satellites) can be used to provide information that may be relevant to a network incident, historical incidents, or information that may be relevant to expected events. Multi-modal data may be able to determine that damage may occur due to increasing weather intensity at various locations in the network. LiDAR data may allow the components or equipment likely to be damaged to be more precisely located in a network or provide additional information. Changes in the multi-modal data may indicate or suggest an impact or growing impact of an event on the network. The output or semantic network state 114 may include this the semantic network state in a vector form. In one example, the semantic network state 114 may represent changes, deteriorations, degradations, damage, intrusions, normality, or other aspects of the network 102 reflected in the multi-modal data 116.

In the context or risk assessment or risk mitigation, the multi-modal data 116, which is distinct from the KPIs 118, may allow the AFM 136 to learn relationships or inter-dependencies between weather conditions and network operations and/or with other types of events. Thus, if a potential weather event is detected based on a forecast, the AFM 136 may use the semantic network state 114 and the request to determine that the potential weather event may adversely impact the network. As such, the command 120 may be preventative or protective in nature.

The network KPIs 118 may include various performance data or indicators. For example, the KPIs 118 may include signal strengths (received/transmitted) of radios, object (e.g., user device) velocities, signal to noise ratios, radio frequency related information, quality of service metrics (e.g., latency, jitter, packet loss), throughput, bandwidth utilization, power consumption, and the like. The KPIs may also contribute to identifying the risks associated with an event and/or a solution to a potential incident.

The prompt generator 134 may receive the semantic network state 114 and the KPIs 118 and the request 122 to generate a prompt to the AFM 136. The request 122 input to the prompt generator 134 includes information related to the event 112. For example, the request 122 may be to upgrade the software of a specific tower in a telecommunications network. This may allow the prompt generator 134 to generate a prompt that includes, in addition to the request, context from the semantic network state 114 and the network KPIs 118.

The semantic network state 114 and network KPIs 118 are typically available in real or near real time to the prompt generator 134. The prompt generator 134 may include all of the KPIs 118 and semantic network state 114 or focus on the portion of the KPIs 118 and semantic network state 114 related to the location of the outage in this example, which may be specified in the request. The prompt 138 is generated and input to the AFM 136.

The AFM 136 is trained on information such as network logs, network reports, standards documents, and the like. This allows the semantic network state 114, KPIs 118 and request 122, reflected in the prompt 138, to be evaluated in light of normal network operation, expected network operation, existing standards, service level agreements, or the like or combinations thereof.

The prompt 138 is received by the AFM 136. The AFM 136 may generate risks associated with the request. The risks may include device failure, service disruption, service degradation, or the like.

The agent 130 may evaluate the solution 142 and issue a control command 120 to the network 102. The control command 120 may be to increase bandwidth, limit or reduce the number of devices able to connect to a particular tower, or the like.

For example, a request to upgrade the firmware of components on a cellular tower may be scheduled. The agent 130 generates a request 122 that specifies the scheduled upgrade. The request may identify the specific components that are impacted, the location of the components, or the like. The prompt generator 132 may then generate a prompt 138 that includes the request 122, the KPIs 118, and the semantic network state 114. If the semantic network state 114 and KPIs 118 indicate that the network is under a heavy burden, the risk of applying the update may be to cause an outage. This may allow the agent 130 to delay the update.

In this example, the agent 130 may be an AI agent. However, the agent 130 may also be a human-in-the-loop.

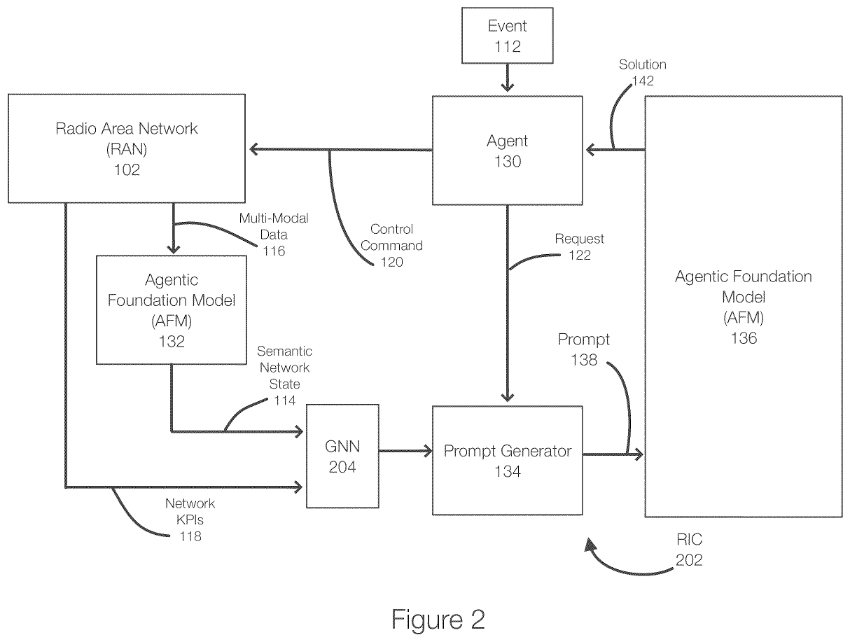

FIG. 2 discloses additional aspects of automated risk management. The RIC 202 in FIG. 2, which is similar to the RIC 140 in FIG. 1C, includes a graph neural network (GNN) 204. In this example, the semantic network state 114 and the network KPIs 118 may be represented in a graph form and may represent current information about the network 102. This information (KPIs and semantic state information or data) is input to a GNN 204 (e.g., in graph form), and the GNN 204 generates an output for the prompt generator 134. The GNN 204 can efficiently output information for each node of the network 102 (e.g., class, learned features, embeddings). The GNN 204 can leverage an intrinsic underlying graphs structure among the components, applications, or entities in the network 102. The GNN 204 is typically executed using the most recently available information relative to the request 122.

The output the GNN 204 is input, along with the request 122, into the prompt generator 134, which generates a prompt 138 to the AFM 136. As previously described, the AFM 136 generates a solution 142, which is evaluated by the agent 130. The agent 130 may issue a control command 120 to resolve the incident in the network 102 in accordance with the solution 142.

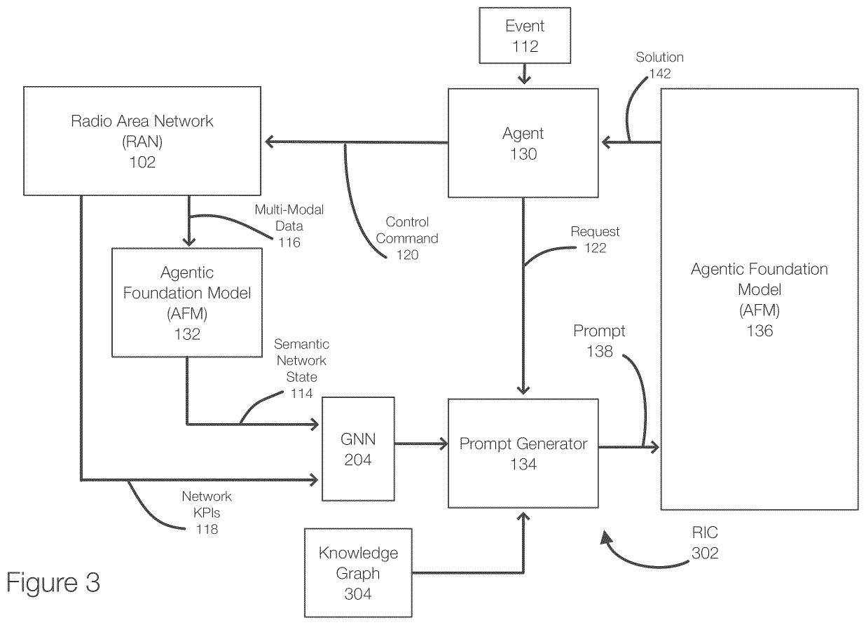

FIG. 3 discloses additional aspects of automated network incident management. FIG. 3 illustrates an RIC 302, which is similar to the RIC 140 and the RIC 202. In this example, the RIC 302 includes a knowledge graph 304. The knowledge graph 304 includes or represents known information relative the network 102. For example, the knowledge graph 304 may include information specific to hardware and applications operating the network such as, but not limited to, version, firmware version, manufacturer, specifications (e.g., power, voltages, transmit/receive power, signal strength, latency, bandwidth) and the like. IN this case, the known information stored in the knowledge graph 304 is distinct from the current data reflecting a current state or operation of the network 102 reflected in the output of the GNN 204 or by the KPIs and semantic state.

In the RIC 302, the prompt generator 134 may generate a prompt 138 that reflects the request 122, an output of the GNN 204 related to the current semantic network state 114 and network KPIs 118, and known data of the network represented in the knowledge graph 304. The knowledge graph 304 may provide additional context for the prompt generator 134.

Embodiments of the invention advantageously improve risk management in an automated manner. Embodiments of the invention reduce the MTTR, should an incident arise, and generate a recommended solution without having to manually review logs, reports, and/or standards. Embodiments of the invention also identify risks associated with an event. This is achieved by integrating AFMs into the RIC. This allows a first AFM to generate a semantic network state that is aware of inter-relations and inter-dependencies to be generated. A second AFM may be used to generate an informed recommended solution based on KPIs, semantic information based on multi-modal data, knowledge graphs, and the like that is also aware of inter-dependencies. The awareness to inter-dependencies comes from being trained with an appropriate dataset, which may include normal data, data associated with incidents of various kinds, data associated with previous events (prior to and/after the events) and the like. Embodiments of the invention also, if desired, facilitate human-in-the-loop input, but may also operate in an automated manner.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, network incident management operations, semantic network state generation operations, solution recommendation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. Further, the AFMs may be trained with historical and/or synthetic data.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method receiving an incident call from a network at an agent in response to a detected incident in the network, generating a request by the agent related to the detected incident, receiving, at a prompt generator, the request, a semantic network state of the network generated by a first model and key performance indicators from the network, generating a prompt based on the request, the semantic network state, and the performance indicators for input to a second model, generating a recommended solution by the second model; and sending a command to the network to resolve the incident.

Embodiment 2. The method of embodiment 1, wherein the agent is a human-in-the-loop or an artificial intelligence agent and the network comprises a heterogeneous telecommunications network.

Embodiment 3. The method of embodiment 1 and/or 2, wherein the key performance indicators comprise radio frequency (RF) data that may include signal strength and signal to noise ratio, bandwidth data, and/or latency data.

Embodiment 4. The method of embodiment 1, 2, and/or 3, wherein the first model comprises a first agentic foundation model or a first large language model and the second model comprises a second agentic foundation model or a second large language model.

Embodiment 5. The method of embodiment 1, 2, 3, and/or 4, wherein the semantic network state is generated from multi-modal data received from the network at the first model, the multi-modal data including one or more of two dimensional image data, three-dimensional image data, and/or light detection and ranging (LiDAR) data.

Embodiment 6. The method of embodiment 1, 2, 3, 4, and/or 5, further comprising receiving the semantic network state and the key performance indicators at a graph neural network, wherein the prompt generator receives an output of the graph neural network, wherein the semantic network state and the key performance indicators are configured as a graph for input to the graph neural network and the output of the graph neural network represents the semantic network state of the network.

Embodiment 7. The method of embodiment 1, 2, 3, 4, 5, and/or 6, wherein the prompt generator is further configured to receive input from a knowledge graph, wherein the knowledge graph represents known information about the network.

Embodiment 8. The method of embodiment 1, 2, 3, 4, 5, 6, and/or 7, wherein the prompt includes data from the request, the semantic network state, the key performance indicators, and the knowledge graph.

Embodiment 9. The method of embodiment 1, 2, 3, 4, 5, 6, 7, and/or 8, further comprising evaluating the recommended solution by the agent prior to sending the command.

Embodiment 10. The method of embodiment 1, 2, 3, 4, 5, 6, 7, 8, and/or 9, wherein the first model is trained with historical multi-modal data and configured to receive multi-modal data as input and the second model is trained on trained on historical data including historical incidents or events, wherein inter-dependencies in the network are represented in the output of the first model and in the risks identified by the second model, wherein the second model further identifies a potential solution to an incident caused by the event that accounts for the interdependencies.

Embodiment 11. The method of embodiment 1, 2, 3, 4, 5, 6, 7, 8, 9, and/or 10, wherein the second model is trained on network logs, network reports, and/or standards.

Embodiment 12. A radio intelligent controller comprising: an agent configured to receive an incident call from a network, a first model configured to receive multi-modal data from the network and output a semantic network state, a prompt generator configured to receive the semantic network state and key performance indicators from the network and build a prompt, a second model configured to receive the prompt and generate a recommended solution to the incident, wherein the agent issues a command to the network to resolve the incident.

Embodiment 13. The radio intelligent controller of embodiment 12, further comprising: a graph neural network configured to receive the key performance indicators and the semantic network state, wherein an output of the graph neural network is input to the prompt generator, and a knowledge base that stores known information about the network, wherein the knowledge base is connected to the prompt generator such that the known information may be reflected in the prompt.

Embodiment 14. A system, comprising hardware and/or software, operable to perform any of the operations, methods, or processes, or any portion of any of these, disclosed herein.

Embodiment 15. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

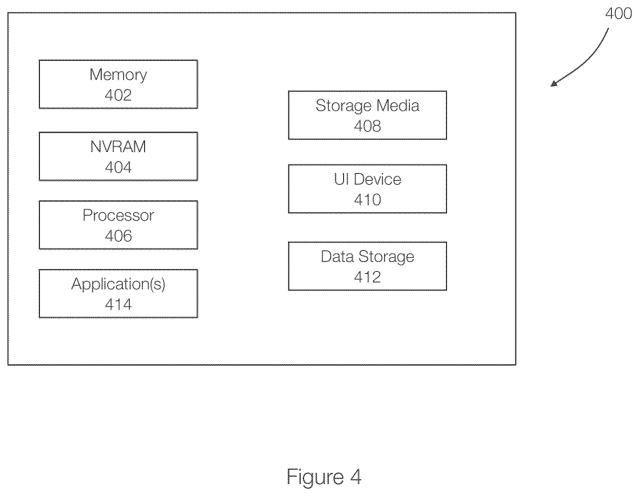

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

The device 400 may also represent a computing system such as a server or set of servers, an edge-based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may also represent a physical or virtual machine or server, an edge-based computing system, a cloud-based computing system, server clusters or other computing systems or environments. The device 400 may also represent multiple machines or devices, whether virtual, containerized, or physical. The device 400 may perform or execute steps or acts of the methods illustrated in the Figures.

The device 400 may represent a cloud-based system, an edge-based, system, an on-premise system, or combinations thereof. Document understanding and related operations may be performed using these types of computing environments/systems.

IN one example, the RIC may be integrated with the network, may be implemented using servers, clusters, or the like. The RIC may include distributed components. Data input to the models may be sourced from multiple locations and multiple models may be used in parallel.

The described embodiments are to be considered in all respects only as illustrative and not restrictive. All changes which come within the meaning and range of equivalency of the claims are to be embraced within their scope.

What is claimed is:

1. A method comprising:
identifying an event related to a network at an agent;
generating a request by the agent related to the detected incident,
receiving, at a prompt generator, the request, a semantic network state of the network generated by a first model and key performance indicators from the network;
generating a prompt based on the request, the semantic network state, and the performance indicators for input to a second model;
identifying risks associated with the event by the second model; and
sending a command to the network to mitigate the risk.

2. The method of claim 1, wherein the agent is a human-in-the-loop or an artificial intelligence agent and the network comprises a heterogeneous telecommunications network.

3. The method of claim 1, wherein the key performance indicators comprise radio frequency (RF) data that may include signal strength and signal to noise ratio, bandwidth data, and/or latency data.

4. The method of claim 1, wherein the first model comprises a first agentic foundation model or a first large language model and the second model comprises a second agentic foundation model or a second large language model.

5. The method of claim 1, wherein the semantic network state is generated from multi-modal data received from the network at the first model, the multi-modal data including one or more of two dimensional image data, three-dimensional image data, light detection and ranging (LiDAR) data and/or sensor data.

6. The method of claim 5, further comprising receiving the semantic network state and the key performance indicators at a graph neural network, wherein the prompt generator receives an output of the graph neural network, wherein the semantic network state and the key performance indicators are configured as a graph for input to the graph neural network and the output of the graph neural network represents the semantic network state of the network.

7. The method of claim 6, wherein the prompt generator is further configured to receive input from a knowledge graph, wherein the knowledge graph represents known information about the network.

8. The method of claim 7, wherein the prompt includes data from the request, the semantic network state, the key performance indicators, and the knowledge graph.

9. The method of claim 8, further comprising evaluating the risks by the agent prior to sending the command.

10. The method of claim 1, wherein the first model is trained with historical multi-modal data and configured to receive multi-modal data as input and the second model is trained on trained on historical data including historical incidents or events, wherein inter-dependencies in the network are represented in the output of the first model and in the risks identified by the second model, wherein the second model further identifies a potential solution to an incident caused by the event that accounts for the interdependencies.

11. The method of claim 1, wherein the second model is trained on network logs, network reports, and/or standards.

12. The method of claim 1, wherein the event includes an upgrade to the network, an update to the network, or is an external event, wherein the second model identifies the risks prior to the event occurring.

13. A non-transitory storage medium having stored therein instructions that are executable by one or more hardware processors to perform operations comprising:
identifying an event related to a network at an agent;
generating a request by the agent related to the detected incident,
receiving, at a prompt generator, the request, a semantic network state of the network generated by a first model and key performance indicators from the network;
generating a prompt based on the request, the semantic network state, and the performance indicators for input to a second model;
identifying risks associated with the event by the second model; and
sending a command to the network to mitigate the risk.

14. The non-transitory storage medium of claim 13, wherein the agent is a human-in-the-loop or an artificial intelligence agent and the network comprises a heterogeneous telecommunications network, wherein the key performance indicators comprise radio frequency (RF) data that may include signal strength and signal to noise ratio, bandwidth data, and/or latency data, wherein the first model comprises a first agentic foundation model or a first large language model and the second model comprises a second agentic foundation model or a second large language model.

15. The non-transitory storage medium of claim 13, wherein the semantic network state is generated from multi-modal data received from the network at the first model, the multi-modal data including one or more of two dimensional image data, three-dimensional image data, light detection and ranging (LiDAR) data and/or sensor data.

16. The non-transitory storage medium of claim 15, further comprising receiving the semantic network state and the key performance indicators at a graph neural network, wherein the prompt generator receives an output of the graph neural network, wherein the semantic network state and the key performance indicators are configured as a graph for input to the graph neural network and the output of the graph neural network represents the semantic network state of the network.

17. The non-transitory storage medium of claim 16, wherein the prompt generator is further configured to receive input from a knowledge graph, wherein the knowledge graph represents known information about the network, wherein the prompt includes data from the request, the semantic network state, the key performance indicators, and the knowledge graph, further comprising evaluating the risks by the agent prior to sending the command.

18. The non-transitory storage medium of claim 13, wherein the first model is trained with historical multi-modal data and configured to receive multi-modal data as input and the second model is trained on trained on historical data including historical incidents or events, network logs, network reports, and/or standards, wherein inter-dependencies in the network are represented in the output of the first model and in the risks identified by the second model, wherein the second model further identifies a potential solution to an incident caused by the event that accounts for the interdependencies wherein the event includes an upgrade to the network, an update to the network, or is an external event, wherein the second model identifies the risks prior to the event occurring.

19. A radio intelligent controller comprising:
an agent configured to identify an event relative to a network;
a first model configured to receive multi-modal data from the network and output a semantic network state;
a prompt generator configured to receive the semantic network state and key performance indicators from the network and build a prompt;
a second model configured to receive the prompt and identify risks associated with the event, wherein the agent issues a command to the network to mitigate the risks.

20. The radio intelligent controller of claim 19, further comprising:
a graph neural network configured to receive the key performance indicators and the semantic network state, wherein an output of the graph neural network is input to the prompt generator; and
a knowledge base that stores known information about the network, wherein the knowledge base is connected to the prompt generator such that the known information may be reflected in the prompt.
